(19) United States
(12) Patent Application Publication
(10) Pub. No.: US 2026/0238632 A1
(43) Pub. Date: Aug. 13, 2026

(54) Method and Apparatus For a Vehicle and a Server

(71) Applicant: Bayerische Motoren Werke Aktiengesellschaft, Muenchen (DE)

(72) Inventors: Harald Hofmeier, Eching (DE); Florian Kotsch, Muenchen (DE); Holger Wierschin, Markt Indersdorf (DE)

(21) Appl. No.: 19/161,208

(22) PCT Filed: Dec. 5, 2023
(86) PCT No.: PCT/EP2023/084281

§ 371 Date: Aug. 29, 2025

(30) Foreign Application Priority Data
Mar. 17, 2023 (DE) 10 2023 106 713.3

(51) Int. Cl. H04L 9/40

(52) U.S. Cl. CPC H04L 63/0823

(57) ABSTRACT

A system for communicating provisioning certificates between a vehicle and two servers is disclosed herein. The vehicle is configured to transmit a first signal indicating that a new primary user has logged onto the vehicle. A first server is configured to receive the first signal indicating that a new primary user has logged onto the vehicle. The first server is further configured to transmit, on a basis of the first signal, at least one second signal indicating that a provisioning certificate for charging contracts which is associated with the vehicle is to be deleted, and that a new provisioning certificate is to be added, wherein the new provisioning certificate is identical to the provisioning certificate which is to be deleted. A second server is configured to receive the second signal from the first server.

### CROSS-REFERENCE TO RELATED APPLICATIONS

The present application is the U.S. national phase of PCT Application PCT/EP2023/084281 filed on Dec. 5, 2023, which claims priority of German patent application No. 10 2023 106 713.3 filed on Mar. 17, 2023, the entire contents of which are incorporated herein by reference.

### FIELD

Exemplary embodiments of the disclosure relate to vehicles a method, a device and a computer program for a server, and to a method, a device and a computer program for a vehicle.

### BACKGROUND

Plug & Charge (a charging standard for the charging of electric vehicles) is based upon industrial standard ISO 15118. By the employment of Plug & Charge, drivers of electric vehicles, for example battery electric vehicles (also described as BEVS) or hybrid vehicles (also described as a PHEV, or plug-in hybrid electric vehicle, a motor vehicle having a hybrid drive, the battery of which can be charged by the engine or by the plug-in of a charging can execute authentication on public charging point simply by the plug-in of the charging cable. Authentication is executed by means of a standard digital contract certificate. The contract certificate includes, inter alia, the contract number. By reference to this number, using existing roaming platforms, the charging point operator (CPO) can complete settlement with respect to the charging process with the contract provider (EMP or MO, the electric mobility provider or the mobility operator, often one and the same as the EMP), or can complete settlement directly with the customer (in the event that the CPO is simultaneously the contract provider). This mode of operation is described in detail hereinafter.

The above-mentioned contract certificates, according to the ISO standard, are associated with a vehicle, and not with a vehicle user. A fundamental prerequisite for the installation of a contract certificate is the “provisioning certificate”, the set-up of which is also specific to the vehicle and which, at the same time, is only present in a singular form. In many cases, however, vehicles, over the service life of a vehicle, are not only used by a single driver, but are also used in parallel or in succession by multiple users. For each vehicle, for example, a designated primary user and, optionally, multiple secondary users can exist, wherein vehicle users can log-on to personal accounts in the vehicle and at other points of contact (e.g. mobile applications). Once set-up, contract certificates are saved, in general by a third party aggregator, and can be installed in the vehicle and employed at any time, provided that the contract is not modified by the provider. From the use of a vehicle by a primary user and by one or more secondary users, it proceeds that contracts of all vehicle users can be employed in the same way. This is potentially problematic, if the employment of specific contracts by specific users only is intended or permitted (for example, in order to execute charging at the expense of an employer). Moreover, in the event of the sale of the vehicle or the return thereof further to a leasing arrangement, deletion of contracts from the vehicle will not be sufficient. In the absence of intervention by the contract provider, the charging contract will remain usable by the subsequent vehicle owner.

In view of the foregoing, it would be desirable to provide an improved concept for securing the charging process, particularly in scenarios in which multiple users enjoy simultaneous or successive access to a vehicle.

### SUMMARY

The present disclosure is based upon the finding to the effect that cryptographically protected methods, which methods are employed, for example, in the Plug & Charge standard for securing charging contracts (i.e. charging certificates), in many scenarios, can result in the conferral of access to the charging contract in favor of unauthorized users. According to the disclosure, this is prevented wherein a server (for example a server of the vehicle manufacturer) is notified to the effect that a new primary user (i.e. for example, a new driver or vehicle owner) is logging onto the vehicle. In this case, the server (of the vehicle manufacturer) notifies a second server (for example, of an aggregation service) to the effect that the provisioning certificate of the vehicle is to be deleted. As a result, invalidation by the second server of contract certificates/charging contracts which are based upon the provisioning certificate is initiated, and mobility operators are notified to this effect. As a result, previously employed certificates can no longer be used. Moreover, the server (of the vehicle manufacturer) notifies the second server (of the aggregation service) to the effect that the addition of a new provisioning certificate is required, which certificate, in turn, is identical to the previously deleted “old” provisioning certificate. This enables the set-up of new contract certificates/charging contracts (for example for the new primary user) which can be installed thereafter, without the necessity for any modification of the provisioning certificate in the vehicle, thereby substantially reducing communication effort.

A first aspect of the present disclosure relates to a computer-implemented method for a server. The method comprises a reception of a first signal, for example from a vehicle, from a mobile application or from another system, wherein the first signal indicates that a new primary user has logged onto the vehicle. The method comprises a transmission, on the basis of the first signal, of at least one second signal for a second server. The at least one second signal indicates that a provisioning certificate for charging contracts which is associated with the vehicle is to be deleted, and that a new provisioning certificate is to be added. The new provisioning certificate is identical to the provisioning certificate which is to be deleted. This ensures that previously installed charging contracts can no longer be used, and thus prevents the use of charging contracts by unauthorized users. By the employment of an identical provisioning certificate, this procedure can be executed without the necessity for a new provisioning certificate to be introduced into the vehicle, as a result of which communication effort can be significantly reduced.

For example, the method can comprise a transmission of a first sub-signal of the second signal which indicates that a provisioning certificate for charging contracts which is associated with the vehicle is to be deleted, and a transmission of a second sub-signal of the second signal which indicates that the addition of a new provisioning certificate is required. As a result, any potential temporal overlap of the two actions which are to be executed, thereby resulting in errors, can be prevented. For example, the second sub-signal can be transmitted further to a stipulated time interval following the delivery of the first sub-signal. A safety margin between the two actions is defined accordingly.

For example, the second sub-signal can comprise the new provisioning certificate. For example, this can be desirable in the event that, at this time, the second server has already deleted the previous provisioning certificate.

In particular, the present disclosure is applicable to the above-mentioned Plug & Charge standard. Correspondingly, at least the second sub-signal can be based upon ISO standard 15118 (for example ISO 15118, ISO 15118-2 or ISO 15118-20). In principle, however, the concept is also applicable to similar standards, or standards which are derived therefrom.

A further aspect relates to a corresponding device comprising at least one interface and at least one control circuit, which device is configured for executing the above-mentioned method for the server. For example, the server can incorporate the device.

A further aspect relates to a corresponding program having a program code for the executing the method for the server, in the event that the program code is executed on a computer, a processor, a control module, a control circuit or a programmable hardware component. For example, the method can be executed by the server, which is a computer and which comprises at least one processor.

A further aspect of the present disclosure relates to a computer-implemented method, for example a method for a vehicle or for another customer interface such as, for example, a mobile application for a mobile device, or for another system. The method comprises an acquisition of a user input, wherein the user input indicates that a new primary user has logged onto the vehicle. The method comprises an invalidation of charging contracts which are associated with the vehicle by the transmission, on the basis of the user input, of a signal to a server. The signal thereby indicates that a new primary user has logged onto the vehicle. As a result, deletion by the server f the provisioning certificate of the vehicle, which certificate is hosted by at least one aggregator service, is initiated, together with the set-up of a new certificate, in an identical form. As a result, with a reduced effort, existing charging contracts can be invalidated and the set-up of new charging contracts executed.

It is possible that the signal, for example, is not transmitted to the server, in the event that the primary user who logs onto the vehicle corresponds to the user who logged on most recently as the primary user of the vehicle. This occurs, for example, further to a return of the motor vehicle, and prevents any necessity for a new set-up of charging contracts for the user, as a result of which communication effort for the installation of charging contracts is obviated.

Further to the invalidation of existing charging contracts, new charging contracts can be loaded, installed and employed. Correspondingly, the method can comprise a reception, further to the invalidation of charging contracts which are associated with the vehicle, of one or more newly set-up charging contracts from the server, and the charging of the vehicle on the basis of the one or more newly set-up charging contracts.

A further aspect relates to a corresponding device comprising at least one interface and at least one control circuit, which device is designed for executing the above-mentioned method for the vehicle. For example, a vehicle can comprise this device.

A further aspect relates to a corresponding program having a program code for the executing the method for the vehicle, in the event that the program code is executed on a computer, a processor, a control module, a control circuit or a programmable hardware component. For example, the method can be executed by the vehicle, for example by means of a controller of the vehicle.

### BRIEF DESCRIPTION OF THE DRAWINGS

Exemplary embodiments are described in greater detail hereinafter with reference to the attached figures. In the figures:

FIG. 1a shows a flow diagram of an exemplary method for a server;

FIG. 1b shows a schematic diagram of a device for a server, and of a system having a server, a second server and a vehicle, a mobile device or another system;

FIG. 2a shows a flow diagram of an exemplary method, for example for a vehicle;

FIG. 2b shows a schematic diagram of a device for a vehicle, and of a system having a vehicle and a server;

FIG. 3 shows a schematic diagram of a technical perspective of Plug & Charge; and

FIG. 4 shows a simplified representation of the technical infrastructure for the employment of Plug & Charge.

### DESCRIPTION

A number of examples will now be described in greater detail with reference to the attached figures. However, further potential examples are not limited to the features of embodiments which are described in detail. These further potential examples can include modifications to features, or equivalences and alternatives to features. Moreover, terminology employed herein for the description of specific examples is not intended by way of limitation of further potential examples.

In the entire description of the figures, identical or similar reference symbols identify identical or similar elements or features, each of which can be implemented in an identical or modified form, whilst executing an identical or similar function. In the figures, moreover, thicknesses of lines, layers and/or regions may be exaggerated, for illustrative purposes.

If two elements A and B are combined by the employment of “or”, it is to be understood thereby that all potential combinations are disclosed, i.e. only A, only B, or A and B, unless expressly defined otherwise in an individual case. As an alternative wording for the same combinations, “at least one of A and B”, or “A and/or B” can be employed. The same applies, in an equivalent manner, to combinations of more than two elements.

If a singular form, e. g. “a, an” and “the” is employed, and the employment of only a single element is neither explicitly nor implicitly defined as mandatory, further examples can also employ multiple elements for the implementation of the same function. If a function described hereinafter is implemented by the employment of multiple elements, further examples can implement the same function by the employment of a single element or a single processing entity. It is understood, moreover, that the terms “incorporates”, “incorporating”, “comprises” and/or “comprising”, by the employment thereof, describe the presence of features, whole numbers, steps, operations, processes, elements or components disclosed, and/or of a group thereof, but do not exclude the presence or addition of one or more further features, whole numbers, steps, operations, processes, elements or components, and/or of a group thereof.

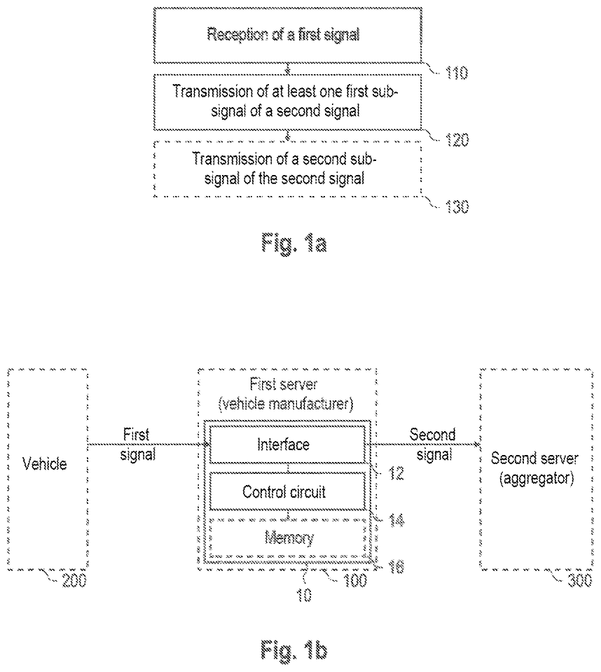

FIG. 1a shows a flow diagram of an exemplary method for a (first) server 100 (represented in FIG. 1b). Reception 110 is executed of a first signal, for example from a vehicle 200 (represented in FIG. 1b), from mobile application of a mobile device, or from another system. The first signal indicates that a new primary user has logged onto the vehicle. The method comprises a transmission 120; 125, on the basis of the first signal, of at least one second signal for a second server 300 (represented in FIG. 1b). The at least one second signal indicates that a) a provisioning certificate for charging contracts, which certificate is associated with the vehicle, is to be deleted, and that b) a new provisioning certificate is to be included. The new provisioning certificate is identical to the provisioning certificate which is to be deleted.

FIG. 1b shows a schematic diagram of a corresponding device 10 for the server 100. The device 10 comprises an interface 12 and a control circuit 14. Optionally, the device 10 further comprises a memory 16. The control circuit 14 is coupled to the interface 12, and to the optional memory 16. The control circuit 14 is designed to deliver the functionality of the device 10, optionally by interaction with the interface 12 (for communication with one or more entities such as, for example, the vehicle 200 or the second server 300) or with the memory 16 (for saving information). For example, the interface 12 can be configured to communicate with the vehicle 200 and/or with the second server via a computer network and/or via the Internet. The device 10 is configured for executing the method according to fig. la. The control circuit 14 can assume the computing functionality, and communication can be executed via the interface 12. The memory 16 can be employed, for example, for saving or buffering information.

FIG. 1b further shows a system having the server 100 and the vehicle 200 (or, alternatively, the mobile device or another system). FIG. 1b further shows a system having the server 100 and the second server 300. FIG. 1b further shows a system having the server 100, the second server 300 and the vehicle 200 (or, alternatively, the mobile device or another system).

Various aspects of the present disclosure address an association of contract certificates (i.e. charging contracts) with a vehicle user, for example in conjunction with Plug & Charge. In the context of the present disclosure, in a server of the vehicle manufacturer (namely, the server 100) which is employed for the administration of contract certificates/charging contracts for vehicles or for the users thereof, a contract certificate can be assigned to a specific user, namely, in particular, the primary user at the time of installation or set-up of the contract. This information can be saved on the server.

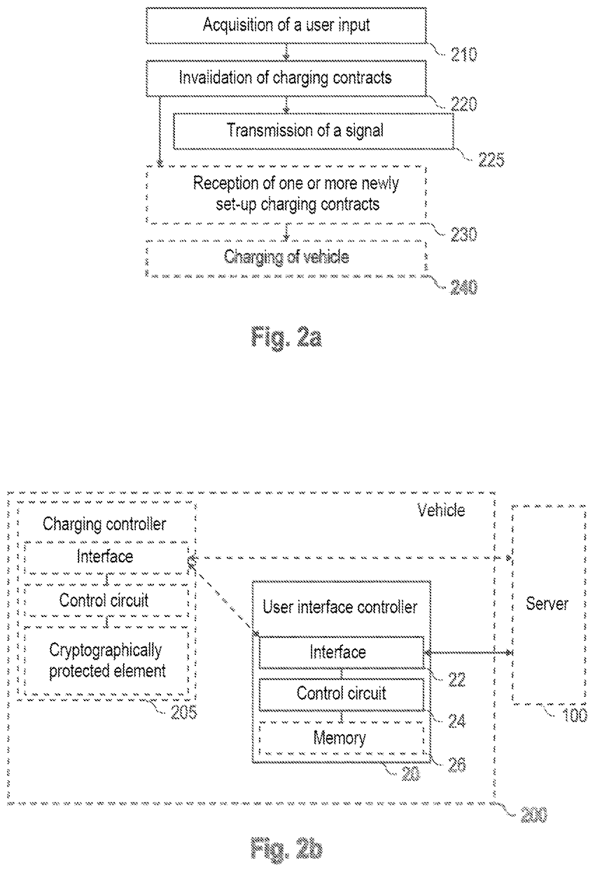

Immediately a new primary user has been registered for the vehicle, the provisioning certificate can be deleted from the server of the vehicle manufacturer, through the offices of the aggregator, and a new set-up thereof executed. Notification of the server to the effect that a new primary user has logged onto the vehicle is executed by the reception 110 of the first signal. In the server, the vehicle, the mobile application or the other system, a database can be hosted, in which information is saved as to which primary user is associated with which vehicle, in order to distinguish whether a new driver has logged-on. In the event of a match with the database of the server, the first signal is thus received therefrom, independently of whether the user who is logging-on as the primary user is a new primary user (i.e. was not logged-on as the primary user immediately prior thereto, which can occur, for example, in the event of a reset of the vehicle). If a match occurs on the vehicle, the mobile application or the other system, as described, for example, in conjunction with FIGS. 2a and 2b, the first signal can be omitted, in the event that the user who is logging-on as the primary user is not a new primary user.

In order to initiate the deletion of the provisioning certificate by the aggregator, the at least one second signal is delivered to the second server. This at least one second signal indicates two circumstances-that the provisioning certificate for charging contracts which is associated with the vehicle is to be deleted, and that a new provisioning certificate is to be deleted. By the installation of a new provisioning certificate, existing contract certificates are deleted. The new primary user thus has no facility for using the contracts of the previous user. Moreover, in the present case, the “old” provisioning certificate is employed as a new provisioning certificate, such that a replacement of the provisioning certificate in the vehicle is not necessary.

In principle, (only) the present primary user is entitled to install contracts on the vehicle. By means of a user interface of the vehicle, or other operator facilities (for example by means of a mobile application), this primary user can enable or disable contracts for further users. This information can be saved locally in the vehicle, or in the above-mentioned server.

For example, it can be stipulated by the vehicle manufacturer that, for the employment of Plug & Charge, a primary user is assigned to a vehicle. The service (which is delivered, for example, by the above-mentioned server) by means of which the administration of provisioning certificates by the vehicle manufacturer is enabled can be associated with the user account administration of the vehicle manufacturer. Immediately the primary user of a specific vehicle assumes an identifier which differs from that of the previous primary user, the service removes the provisioning certificate from the backend (i.e. from the second server)/pool of the aggregator and, after a short time interval, restores the certificate to the same pool. Correspondingly, the at least one second signal can comprise two sub-signals. Correspondingly, the method can comprise a transmission 120 of a first sub-signal of the second signal which indicates that a provisioning certificate for charging contracts which is associated with the vehicle is to be deleted, and a transmission 125 of a second sub-signal of the second signal which indicates that a new provisioning certificate is to be added. In order to ensure that deletion has been executed, and that there is no overlap thereof with the installation of the new provisioning certificate, the second sub-signal can be transmitted upon the expiry of a stipulated time interval following the delivery of the first sub-signal. The second sub-signal can comprise the new provisioning certificate (or a public element/key thereof) which corresponds to the first provisioning certificate. The second signal (for example, both sub-signals thereof) can be based upon ISO standard 15118, and specifically upon ISO 15118-2 or ISO 15118-20. Removal of the certificate from the pool of the aggregator is interpreted by the aggregator as the “deletion” of the vehicle. As a result, the aggregator deletes all previously set-up contracts from their database. The aggregator moreover interprets the re-entry of the provisioning certificate as a new vehicle. As a result, for example, no previously existing contract certificates are restored, or similar.

If the new primary user in the vehicle now retrieves the Plug & Charge menu, and wishes to display contracts which are in force for this vehicle, this list will be blank (i.e. no contracts of a preceding primary user are visible and/or usable), until such time as this user, in turn, concludes their own contract for this vehicle.

The proposed concept can be employed, for example, if the provisioning certificate is associated with the vehicle and the provisioning certificate identifier (PCID) remains unchanged over the lifetime of the vehicle.

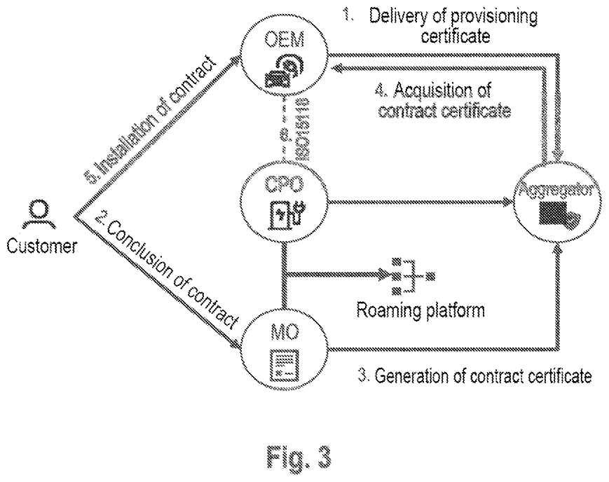

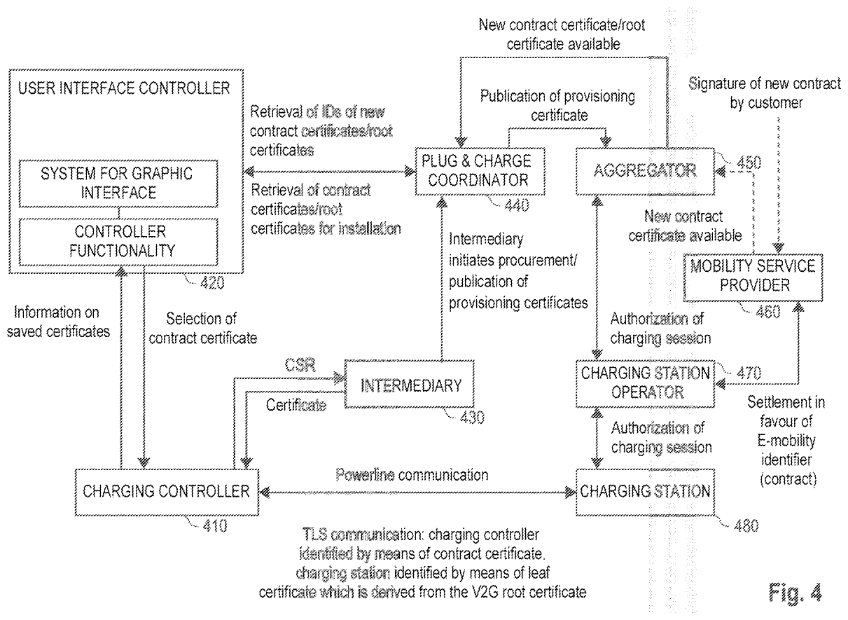

Further information with respect to the provisioning certificate and communication between the various entities involved in the charging standard is discussed, in particular, in conjunction with FIGS. 3 and 4.

The interface 12 can correspond, for example, to one or more inputs and/or one or more outputs for the reception and/or transmission of information, for example in digital bit values, on the basis of a code, with a module, between modules, or between modules of different entities. For example, the interface 12 can be configured for communication via a computer network.

In the exemplary embodiments, the control circuit 14 can correspond to an arbitrary controller or processor, or to a programmable hardware component. For example, the control circuit 14 can also be embodied as a software which is programmed for a corresponding hardware component. The control circuit 14 can thus be implemented in the form of a programmable hardware having a correspondingly adapted software. Arbitrary processors, such as digital signal processors (DSPs) can be employed. Exemplary embodiments are not limited to a specific type of processor. The implementation of arbitrary processors, or of multiple processors, is also conceivable.

The memory 16 of the charging controller can comprise, for example, at least one element of the group comprised of a computer-readable storage medium, a magnetic storage medium, an optical storage medium, a hard disk, flash memory, diskette, random access memory (RAM), programmable read only memory (PROM), erasable programmable read only memory (EPROM), electronically erasable programmable read only memory (EEPROM), and a network memory.

Further details and aspects of the method, of the

corresponding device, of the server and of a corresponding computer program are specified in conjunction with the concept of the examples described hereinafter (e.g. with respect to FIGS. 2a to 4). The method, the device, the server and the computer program can comprise one or more additional optional features which correspond to one or more aspects of the proposed concept or the examples described, as represented heretofore or hereinafter.

FIG. 2a shows a flow diagram of one exemplary method, for example a method for a vehicle 200 (represented in FIGS. 1b and 2b), or for a mobile device or another system. The method comprises an acquisition 210 of a user input. The user input indicates that a new primary user is logging onto the vehicle. The method comprises an invalidation 220 of charging contracts which are associated with the vehicle, by the transmission 225, on the basis of the user input, of a signal to a server. The signal indicates that a new primary user has logged onto the vehicle.

For example, the method can be executed by the vehicle 200, for example by means of a controller 20 of the vehicle. Alternatively, the method can be executed by a mobile device (for example a mobile application) or by another system. For example, the controller 20, also described hereinafter as a device 20, can be a “head unit” of the vehicle, or a user interface controller. Correspondingly, the device 20/user interface controller 20 can be configured to deliver information for a user of the vehicle via a user interface within the vehicle (for example a touchscreen) or externally to the vehicle (for example via a mobile device) and/or to acquire a user input.

FIG. 2b shows a schematic diagram of a device 20 (for example a user interface controller 20) for a vehicle 200, and of a system having a vehicle 200 and a server 100 (as known from FIG. 1b). The device is a device for a vehicle. Alternatively to a vehicle, however, the device can also be implemented in a mobile device or in another system. The device 20 comprises at least one interface 22, a control circuit 24, and an optional memory 26. The control circuit 24 is coupled to the at least one interface 22, and to the optional memory 26. The control circuit 24 is designed to deliver the functionality of the device 20, optionally by interaction with the interface 22 (for communication with one or more entities such as, for example, a charging controller 205 of the vehicle 200 or a server 100) or with the memory 26 (for saving information). For example, the interface 22 can be configured to communicate with the server 100 via a computer network and/or via the Internet, and to communicate with the charging controller 250 via a vehicle network. The device 20 is configured for executing the method according to FIG. 2a. The control circuit 24 can assume the computing functionality, and communication can be executed via the interface 22. The memory 26 can be employed, for example, for saving or buffering information.

Whereas FIGS. 1a and 1b primarily address the server 100 of the vehicle manufacturer, FIGS. 2a and 2b address the vehicle. According to the present disclosure, the process is initiated wherein a new primary user logs onto the vehicle. It is still possible for only one (single) primary user to be logged onto the vehicle. Under normal circumstances, the primary user is the owner (or lessee) of the vehicle. In addition to the primary user, optionally, one or more secondary users can also use the vehicle, with the permission of the primary user. In the event that a secondary user logs on, the present process is not initiated.

The method comprises the acquisition 210 of a user input, wherein the user input indicates that a new primary user is logging onto the vehicle. This user input can be received, for example, via the user interface of the vehicle or of the mobile device. The primary user can log onto the vehicle, as the primary user, by the entry of a user name (for example, an E-mail address) and a password. If this is the case, it is then assumed that ownership of the vehicle has been transferred, and that the previous primary user no longer has access to the vehicle. This also means that, automatically, charging contracts which are presently available in the vehicle are invalidated. According to the present disclosure, this invalidation is executed automatically wherein, by means of the signal, the server 100 is notified to the effect that a new primary user has logged onto the vehicle.

In some cases, it can occur that a new primary user logs onto the vehicle, which primary user, however, does not correspond to the previous primary user. This can occur, for example, in the event that the vehicle is returned for the correction of a fault. In this case, the previous primary user corresponds to the new primary user. In order to prevent the invalidation of charging contracts in this case, it is possible, for example, that the signal is not transmitted to the server, in the event that the primary user who is logging onto the vehicle corresponds to the user who most recently logged onto the vehicle as the primary user. This can be executed, for example, by means of the database described in conjunction with FIGS. 1a and 1b for the association of a vehicle with a primary user.

Once the previous charging contracts have been invalidated, new charging contracts can be set up on the basis of the provisioning certificate which is present in the vehicle, introduced into the vehicle and employed for charging. Correspondingly, the method, as further represented in FIG. 2a, can comprise a reception 230, further to the invalidation of charging contracts which are associated with the vehicle, of one or more newly set-up charging contracts from the server, and the charging 240 of the vehicle on the basis of the one or more newly set-up charging contracts.

In particular, at least one of the newly-received charging contracts can be loaded by the device 20 into a cryptographically protected element of the charging controller 205 wherein, by means of the private key of the provisioning certificate which is present therein, the decryption thereof can be executed. The charging contract can then be employed for authenticating the charging controller vis-à-vis a charging infrastructure.

The at least one interface 22 can correspond, for example, to one or more inputs and/or one or more outputs for the reception and/or transmission of information, for example in digital bit values, on the basis of a code, with a module, between modules, or between modules of different entities.

In the exemplary embodiments, the control circuit 24 can correspond to an arbitrary controller or processor, or to a programmable hardware component. For example, the control circuit 24 can also be embodied as a software which is programmed for a corresponding hardware component. The control circuit 24 can thus be implemented in the form of a programmable hardware having a correspondingly adapted software. Arbitrary processors, such as digital signal processors (DSPs) can be employed. Exemplary embodiments are not limited to a specific type of processor. The implementation of arbitrary processors, or of multiple processors, is also conceivable.

The vehicle 200 can correspond, for example, to a land vehicle, a watercraft, an aircraft, a rail-mounted vehicle, a road vehicle, an automobile, an off-road vehicle, a motor vehicle or a heavy goods vehicle.

Further details and aspects of the charging controller, the corresponding method and the computer program are specified in conjunction with the concept or the examples described heretofore or hereinafter (e.g. with reference to FIGS. 1a to 1b, or 3 to 4). The charging controller, the corresponding method and the computer program can comprise one or more additional optional features which correspond to one or more aspects of the proposed concept or the examples described, as represented heretofore or hereinafter.

A brief overview is provided hereinafter of Plug & Charge mechanisms, as employed in the present invention, in the interests of further understanding. Plug & Charge enables a fully-automated and secure charging experience by the employment of EV authentication technology at a charging station (in accordance with ISO 15118). FIG. 3 shows a schematic diagram of a technical perspective of Plug Charge. Firstly (1.), the vehicle manufacturer (represented in FIG. 3 as the OEM, for example the first server according to FIG. 1b) delivers a provisioning certificate to an aggregator (for example to the second server 300 according to FIG. 1b). The vehicle user then concludes a charging contract with the mobility operator (MO). In the context of the conclusion of the charging contract, the vehicle user communicates the vehicle identification number (for example, the PCID, or provisioning certificate identifier), which communication can be executed, for example, through the offices of the vehicle manufacturer. The mobility operator sets up a contract certificate (3.) for the vehicle identification number thus disclosed, which contract certificate is also supplied to the aggregator. The aggregator notifies the OEM (4.) to the effect that a contract certificate has been received, and executes the optional relaying thereof (or the contract certificate is retrieved by the OEM, as required). The customer instructs the vehicle manufacturer and, in particular, the vehicle, to download and install the contract certificate (5.). In the context of the charging process, the vehicle manufacturer or the vehicle communicates (6.) with the charging point operator (CPO) in accordance with ISO 15118, which CPO, in turn, can then establish contact with the mobility operator, through the offices of the aggregator and/or a roaming platform, with respect to settlement of the charging process.

FIG. 4 shows a simplified representation of the technical infrastructure for the employment of Plug & Charge. FIG. 4 shows a charging controller 410 (which can correspond to the charging controller 205 according to FIG. 2b), a user interface controller 420 which can correspond to the controller 200 according to FIGS. 1a and 1b, an intermediary 430 (which can be employed in the vehicle or in conjunction with the manufacture of the vehicle), a Plug Charge coordinator 440 (of the vehicle manufacturer) which can correspond to the first server 100 according to FIGS. 1b and 2b, an aggregator 450 which can correspond to the second server 300 according to FIG. 1b, a mobility service provider 460, a charging station operator 470 and the charging station 480. The charging controller 410 is configured for communication in accordance with ISO 15118, and is responsible for the saving and management of certificates (including diagnostic orders). The intermediary is the root certification authority of the vehicle manufacturer, and issues provisioning certificates.

In order to install a new contract in the vehicle, particularly in the charging controller, the following steps can be executed. In order to enable the installation of charging contracts (or of corresponding certificates), a “provisioning certificate” is required. In the present example, this office is executed by the intermediary 440. The latter receives a certificate signing request (CSR) from the charging controller, and delivers a private key for the certificate to the charging controller 430, and a public key to the Plug & Charge coordinator 440. The latter discloses the provisioning certificate (i.e. the public key thereof) to the aggregator 450. The provisioning certificate contains a cryptographically protected identifier of the vehicle (for example, the chassis number).

By the signature of a charging contract, as an element of the contract, the customer discloses the vehicle identifier to the mobility service provider 450. The latter generates a new contract certificate. The contract certificate can now be encrypted by means of the provisioning certificate (i.e. the public key thereof), such that the decryption thereof by a charging controller is enabled, which charging controller has access to the private key of the provisioning certificate. The appropriate provisioning certificate is ascertained by means of the identifier. The aggregator 450 receives the encrypted contract certificate and notifies the Plug & Charge coordinator 440 thereof. The latter can now receive the contract certificate and execute the delivery thereof to the charging controller, for example via a telematic connection. Alternatively, the contract certificate can be exchanged by means of powerline communication between the charging station 480 and the charging controller 410. If the charging controller has access to a corresponding contract certificate, identification of the contract certificate can be executed in the context of TLS (transport layer security) communication. The charging station identifies itself by means of a leaf certificate, which is derived from a V2G (vehicle-to-grid) root certificate. Authorization for the charging session is executed between the charging station 480, the charging station operator 470 and the aggregator 450, wherein the charging station operator 470 can ascertain the mobility service provider 460 through the offices of the aggregator 450. Settlement is then executed, in accordance with the contract, by means of an E-mobility identifier, in favor of the mobility service provider 460.

The user interface controller comprises a system for a graphic interface which can be based, for example, upon a graphic operating system for mobile devices, and which can enable on-board user control, the configuration of the vehicle and of the Plug & Charge functionality, together with the actual controller functionality. The latter communicates with the charging controller 410, and receives information on provisioning and contract certificates which are saved therein from the charging controller 410. For example, a user can log onto the vehicle via the user interface controller, in response to which the corresponding provisioning certificate and contract certificate are activated. Via the graphic interface system, an option for the selection of one of the saved certificates can now be entered, wherein this selection is communicated to the charging controller. The user interface controller 420 moreover requests identifiers for new contract certificates (and V2G root certificates) from the Plug & Charge coordinator 440, in order to enable the installation of contract certificates to be proposed. If installation is initiated, the user interface controller 420 then requests the respective certificates for installation from the Plug & Charge coordinator. These certificates can then be relayed to the charging controller. For the purposes of communication between the user interface controller 420 and the charging controller 410, a diagnostic communication and/or a status/configuration communication can be employed.

Aspects and features described in conjunction with a specific above-mentioned example can also be combined with one or more of the further examples, by way of replacement of an identical or similar feature of this further example, or by way of the inclusion of this feature in the further example.

Examples can further comprise a (computer) program having a program code for the execution of one or more of the above-mentioned methods, or can relate thereto, in the event that the program is executed on a computer, a processor or another programmable hardware component. Steps, operations or processes of various of the above-mentioned methods can thus be executed by means of programmable computers, processors or other programmable hardware components. Examples can also encompass program storage devices, e.g. digital data storage media which are machine-, processor- or computer-readable, and which encode or contain machine-executable, processor-executable or computer-executable programs and instructions. Program storage devices can incorporate or comprise e.g. digital memories, magnetic storage media such as, for example, magnetic disks and magnetic tapes, hard drives or optically-readable digital data storage media. Further examples can also encompass computers, processors, computers, (field) programmable logic arrays ((F) PLAS), (field) programmable gate arrays ((F) PGAs), graphics processor units (GPUs), application-specific integrated circuits (ASICs), integrated circuits (ICs) or systems-on-a-chip (Soc) which are programmed for executing the steps of the above-mentioned method.

It is further understood that the disclosure of multiple steps, processes, operations or functions which are disclosed in the description or in the claims does not necessarily imply the configuration thereof in the sequence described therein, unless this is specifically indicated in an individual case, or is absolutely necessary on technical grounds. Consequently, the preceding description of the execution of multiple steps or functions is not limited to a specific sequence. Moreover, in further examples, an individual step, an individual function, an individual process or an individual operation can encompass multiple sub-steps, sub-functions, sub-processes or sub-operations and/or can be subdivided into same.

In the event of the description of certain aspects, in the preceding paragraphs, in conjunction with a device or a system, these aspects are also to be understood as a description of the corresponding method. Thus, for example, a unit, a device, or a functional aspect of the device or of the system can correspond to a feature, for example a process step, of the corresponding method. Correspondingly, aspects which are described in conjunction with a method are also to be understood as a description of a corresponding unit, a corresponding element, a property or a functional feature of a corresponding device or of a corresponding system.

The following claims are incorporated in the detailed description, wherein each claim can represent a separate example per se. It should further be observed that-although a dependent claim, in the claims, relates to a specific combination thereof with one or more further claims—further examples can also comprise a combination of the dependent claim with the subject matter of any other dependent or independent claim. Such combinations are thus explicitly proposed unless, in a specific case, it is indicated that a specific combination is not intended. It is also intended that the features of a claim are included in any other independent claim, even in the event that this claim is not defined as directly dependent upon said other independent claim.

### LIST OF REFERENCE NUMBERS

10 Device
12 Interface
14 Control circuit
16 Memory
20 Device
22 Interface
24 Control circuit
26 Memory
100 Server
110 Reception of a first signal
120 Transmission of first sub-signal of a second signal
125 Transmission of a second sub-signal of the second signal
200 Vehicle
205 Charging controller
210 Acquisition of a user input
220 Invalidation of charging contracts
225 Transmission of a signal
230 Reception of one or more newly set-up charging contracts
240 Charging of vehicle
300 Second server
410 Charging controller
420 User interface controller
430 Intermediary
440 Plug & Charge coordinator
450 Aggregator
460 Mobility service provider
470 Charging station operator
480 Charging station

What is claimed is:

1.-10. (canceled)

11. A computer-implemented method for communicating provisioning certificates between a vehicle and two servers, the method comprising:
receiving a first signal at a first server, wherein the first signal indicates that a new primary user has logged onto the vehicle; and
transmitting, on a basis of the first signal, at least one second signal to a second server, wherein the at least one second signal indicates that a provisioning certificate for charging contracts which is associated with the vehicle is to be deleted, and that a new provisioning certificate is to be added, wherein the new provisioning certificate is identical to the provisioning certificate which is to be deleted.

12. The method as claimed in claim 11, wherein the method further comprises transmitting a first sub-signal of the second signal which indicates that a provisioning certificate for charging contracts which is associated with the vehicle is to be deleted, and transmitting a second sub-signal of the second signal which indicates that an addition of a new provisioning certificate is required.

13. The method as claimed in claim 12, wherein the second sub-signal comprises the new provisioning certificate.

14. The method as claimed in claim 13, wherein the second sub-signal is transmitted further to a stipulated time interval following delivery of the first sub-signal.

15. The method as claimed in claim 14, wherein at least the second signal is based upon ISO standard 15118.

16. A computer-implemented method for determining charging contracts for a vehicle, which method comprises:
acquisition of a user input, wherein the user input indicates that a new primary user has logged onto the vehicle; and
invalidation of charging contracts which are associated with the vehicle by transmission, on a basis of the user input, of a signal to a server, wherein the signal indicates that a new primary user has logged onto the vehicle.

17. The method as claimed in claim 16, wherein the signal is not transmitted to the server in an event that the primary user who logs onto the vehicle corresponds to the user who logged on most recently as the primary user of the vehicle.

18. The method as claimed in claim 17, further comprising a reception, further to the invalidation of charging contracts which are associated with the vehicle, of one or more newly set-up charging contracts from the server, and the charging of the vehicle on the basis of the one or more newly set-up charging contracts.

19. A non-transitory computer-readable medium having a program code for executing the method of claim 16.

20. A system for communicating provisioning certificates between a vehicle and two servers, the system comprising:
a vehicle configured to transmit a first signal indicating that a new primary user has logged onto the vehicle;
a first server configured to receive the first signal, the first server including at least one interface and at least one control circuit, the at least one control circuit configured to:
receive the first signal at a first server, wherein the first signal indicates that a new primary user has logged onto the vehicle; and
transmit, on a basis of the first signal, at least one second signal indicating that a provisioning certificate for charging contracts which is associated with the vehicle is to be deleted, and that a new provisioning certificate is to be added, wherein the new provisioning certificate is identical to the provisioning certificate which is to be deleted; and
a second server configured to receive the second signal from the first server.

21. The system of claim 20, wherein the control circuit is further configured to transmit a first sub-signal of the second signal which indicates that a provisioning certificate for charging contracts which is associated with the vehicle is to be deleted, and transmit a second sub-signal of the second signal which indicates that an addition of a new provisioning certificate is required.

22. The system of claim 21, wherein the second sub-signal comprises the new provisioning certificate.

23. The system of claim 22, wherein the second sub-signal is transmitted further to a stipulated time interval following delivery of the first sub-signal.

24. The system of claim 23, wherein at least the second signal is based upon ISO standard 15118.

25. The system of claim 23 wherein the vehicle is further configured to display a menu with an option to display a list of contracts which are in force for the vehicle.

26. A non-transitory computer-readable medium having a program code for executing the method of claim 11.

27. The method of claim 15 wherein the first server is a vehicle manufacturer server.

28. The method of claim 27 wherein the second server is an aggregation service server.
